(19) United States
(12) Patent Application Publication
(10) Pub. No.: US 2022/0154072 A1
(43) Pub. Date: May 19, 2022

(54) METHOD OF REDUCING THE SWELLING CAPACITY OF CLAY-CONTAINING SOIL

(71) Applicants: Hayward Baker, Inc., Little Elm, TX (US); Keller Holding GMBH, Offenbach/Main (DE)

(72) Inventor: Art Pengelly, Southlake, TX (US)

(21) Appl. No.: 17/385,183

(22) Filed: Jul. 26, 2021

Related U.S. Application Data
(63) Continuation of application No. PCT/US19/15177, filed on Jan. 25, 2019.

(51) Int. Cl. C09K 17/50; E02D 3/12

(52) U.S. Cl. CPC C09K 17/50; E02D 3/12

(57) ABSTRACT

A method and composition for reducing the swelling capacity of clay-containing soil, thus lowering volume change in soil, and thus enhancing the stability of soil, particularly expansive clay soil, in order that it is sufficiently stable, such that roads, pavements and some types of buildings and other structures can be securely constructed thereon. The method also minimizes any swelling and/or shrinkage in the soil under any such structures due to the movement of moisture in the soil, and thus minimizes damage and deterioration caused to such structures due to the presence of too much, or too little, water in the soil thereunder.

### CROSS-REFERENCE TO RELATED APPLICATION(S)

The present application is a continuation of PCT/US19/15177 filed 25 Jan. 2019.

### BACKGROUND OF THE INVENTION

### 1. Field of the Invention

The present invention relates to soil improvement and, more particularly to a method of reducing the swelling capacity of clay-containing soil.

### 2. Description of the Background

Damage to structures constructed on expansive clay soils occurs throughout the world each year. The extent to which expansive clay soils can damage an individual structure foundation depends largely on the amount and location of moisture change in the soil beneath that foundation, as well as the foundation's stiffness. Significant changes in moisture levels typically occur from poor drainage and/or from large vegetation nearby, which cause heave or shrinkage, respectively.

Once a structure has experienced damaging differential movements and repair is needed, an engineer must consider the sources and magnitudes of previous and future movements of moisture when designing repairs.

Laboratory research on the effects of potassium and sodium has been carried out by various authors who validated the beneficial effect of these cations on the limitation of swelling and/or shrinkage. Norrish (1954) performed extensive X-ray diffraction (XRD) studies on Wyoming bentonite (montmorillonite) samples after exposure to various electrolytes to study their swelling characteristics. Norrish, K, The Swelling of Montmorillonite, Discussions of the Faraday society, 18, 120-133 (1954). That research was performed on oriented montmorillonite platelets, which had been dried from a suspension containing particles less than 0.1 microns in size. Dried flakes, 0.03 mm thick, were put in 0.3 to 0.7 mm capillary tubes, and then exposed to different electrolytic salts. After equilibrating in scaled tubes, the samples were studied by XRD while enclosed in the sealed tubes. The electrolytes evaluated included H30+, Li+, Na+, NH4+, K+, Cs+, Mg2+, Ca2+, and A 13+.

XRD results indicated that only the NH4+, K+, and Cs+ treated samples did not swell. Norrish, supra, attributed the degree of crystalline swelling to the hydration energies of these mono-valent cations.

In a study of the effects that potassium concentrations have on crystalline swell, Denis et. al, (1991) analyzed XRD data of samples of a standard Wyoming montmorillonite. Denis, J. H., Keall, M. J., Hall, P. L., and Meeten, G. H., Influence of Potassium Concentration on the Swelling and Compaction of Mixed (Na, K) Ion-Exchanged Montmorillonite, Clay Minerals, 26, 255-268 (1991). Samples were prepared in such a manner that mixed sodium and potassium exchanged clays were fabricated by slurrying together aqueous suspensions of pure sodium and pure potassium montmorillonite clays. Atomic emission spectroscopy was used to determine the compositions of the resulting mixed clays.

Dried specimens were prepared for XRD analysis, but the samples were allowed to equilibrate in differing relative humidities. Interlayer spacings (dOO1) were recorded for differing percentages of potassium at differing relative humidities.

A representative portion of that data, plotted in FIGS. 2-6 therein, revealed increasing crystalline swell with increasing relative humidities for all percentages of K+ as anticipated. However, it also indicated lower crystalline swell with increasing K+ concentration at the same relative humidity. These findings supported the conclusions of Norrish, supra, that increasing K+ concentration results in less swell.

Grimm (1968) indicated that increased concentration of the replacing cation causes greater exchange by that cation due to the laws of mass action. Grimm, R. E., Clay Mineralogy, McGraw-Hill, n. e. (Ed.), New York. pp. 596 (1968).

Allison et al., (1953) indicated that where montmorillonite is the dominant clay mineral, NH4+, which possesses a very similar ionic replaceability as K+, has exchange values which are about one-half those for illitic soils. Allison F E, Doetsch J H, Roller E., Availability Of Fixed Ammonium In Soils Containing Different Clay Minerals, Soil Sci 75:373-381(1953). Cationic replacements results in reduction of the overall system energy.

Lime slurry pressure injection (LSPI) was developed in the early 1960's. R. S. Boynton, J. R. Blacklock, Lime Slurry Pressure Injection, Bulletin, National Lime Association, Bulletin 331, Arlington, Va. (1985). Increasing use and acceptance of this method of treatment has occurred since then throughout the United States.

Practicing geotechnical engineers familiar with the process indicate that lime slurry pressure injected subgrades are primarily pre-swelled and partially modified, since lime only coats desiccated block-like portions of the subgrade, rather than fully penetrating and modifying the soil throughout the block.

A comprehensive statistical investigation was performed by Petry et al, (1992) to provide “ . . . information about the changes to physical and chemical properties that occur in an active clay soil during and shortly after injection with lime and lime and fly ash slurries.” Petry, T. M. and Little, D. N, “Update on Sulfate Induced Heave in Lime and Portland Cement Treated Clays: Determination of Potentially Problematic Sulfate Levels”, Transportation Research Board, Transportation Research Record 1362, pp. 51-55 (1992). Comparison studies of chemical modification from field injections of lime slurry followed by three injections of water with surfactant, double lime slurry injections and double lime/fly ash slurry injections, were made. Properties measured before and after injections in that study included moisture content, Atterberg limits, linear shrinkage, swell and swell pressure, pH, CEC, pore water cations and exchange complex cations. In statistically interpreting the data collected, Petry et al, supra, stated “ . . . there was more variance within each treatment set of pads than within or between the pads of each treatment.” The researchers also discovered that only 22% of the comparisons between average values of various tests for before and after treatment properties were statistically different. Those findings supported the belief that stabilization after LSPI is restricted only to areas which are located immediately adjacent to slurry distribution seams. Petry (1980) has also indicated that calcium cations from lime slurry pressure injection migrate and diffuse into the soil between lime filled scams only at rates of 2.54 cm (1 inch) in 100 days to 15.24 cm (6 inches) in 3600 days. Ingles and Neal (1970) also report very low penetration of pressure injected lime into the soil mass.

Even though chemical stabilization is not a major resultant effect of LSPI, additional benefits besides pre-swelling are realized. Boynton and Blacklock, supra, stated: “The formation of relatively thin lime or lime/fly ash seams (stabilization seams) helps to stabilize the moisture content of the treated soil mass. These stabilization seams serve as moisture barriers and impede the movement of capillary as well as seasonal moisture through the soil. These seams help to retain the moisture from the slurry that was injected into the soil. By thus encapsulating large volumes of clay, the volume change potential of the soil is greatly reduced,”

Petry et al, (1982) monitored surficial movements of the sixteen pad sites involved in the study at time intervals starting two months before injection, during injection and for approximately one year following injection. T. M. Petry, C. J., Armstrong. and D. T. Chang, “Short-Term Active Soil Property Changes Caused by Injection of Lime and Fly Ash, Transportation Research Record 839, TRB, National Research Council, Washington D.C., 1982, pp. 26-32 (1982). Analysis of that surveying data revealed that the pads treated with one lime slurry pressure injection followed by three water with surfactant injections, and those treated with double lime slurry pressure injections, both experienced approximately one-half of the drying shrinkage and one-half as much heaving upon wetting as the untreated pad sites. The pads were unprotected and all exposed to full climatic conditions throughout the investigation. In evaluating the comprehensive laboratory and field movement data, Petry et al., supra, concluded that a lime slurry pressure injected subgrade, followed by three injections of water with surfactant, provided the best stabilization of the various lime methods compared.

Further formulations have previously been employed in improving soil stabilization and soil engineering properties. These include a mixture of sodium chloride and gypsum (Murthy et al, International Journal of Advances in Engineering and Technology; Vol. 9; Issue 5; pp. 569-581 (October 2016); or a vinyl acetate homopolymer emulsion comprising (i) vinyl acetate, hydroxyethyl cellulose, a non-atonic ethoxylated surfactant, potassium persulfate, sodium bicarbonate and water, (ii) a polyvinyl alcohol mixture comprising water, hydrogen peroxide, glycerin and polyvinyl alcohol; and (iii) a water repellent emulsion which comprises paraffin wax, an ethoxylated surfactant, diglycol stearate, candelilla wax, stearic acid, water, zirconium acetate, and ethylene urea resin (see U.S. Pat. No. 3,887,506); or a water-soluble strongly alkaline liquid phenol-formaldehyde resin having a pH of at least 9.5 and having a molar ratio of phenol to formaldehyde between 1:1.5 and 1:3.0, and a lactone present in an amount of 1 to 30 percent of the liquid resin (U.S. Pat. No. 3,599,433).

However, there remains a need for a method of stabilizing soil using a cation-containing composition which is able to reduce swelling and/or shrinkage of swelling clays substantially immediately during injection and in the long term, and which makes the cation-containing solution more effective in a largest possible radius of action. The cation-containing solution must also not be harmful to the underground environment.

### SUMMARY OF THE INVENTION

Accordingly, it is an object of the present invention to provide a method reducing the swelling capacity of clay-containing soil.

It is another object to provide a method of stabilizing soil using a cation-containing composition which is able to reduce swelling and/or shrinkage of swelling clays substantially immediately during injection and in the long term, and which makes the cation-containing solution more effective in a largest possible radius of action.

It is still another object to provide a method of stabilizing soil using a cation-containing composition which is not harmful to the underground environment.

In accordance with the above-described objects, a method of stabilizing soil is herein disclosed comprising introducing a liquid composition comprising one or more potassium or ammonium salts and a lignin into the soil, thus lowering volume change in soil, reducing the swelling capacity of some types of clay soil, and thus enhancing the stability of soil, particularly expansive clay soil, in order that it is sufficiently stable, such that roads, pavements and some types of buildings and other structures can be securely constructed thereon. The method and composition reduce the swelling capacity of soil which contains clay, and also lowers the volume change in such soil by reducing swelling and/or shrinkage of the soil from a first level before injection of the composition into the soil, to a second, lower level, after injection of the composition into the soil, which is a swelling or expansive clay soil.

The method also minimizes any swelling and/or shrinkage in the soil under any such structures due to the movement of moisture in the soil, and thus minimizes damage and deterioration caused to such structures due to the presence of too much, or too little, water in the soil thereunder.

For a more complete understanding of the invention, its objects and advantages, refer to the remaining specification and to the accompanying drawings.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 shows a graph illustrating the level of swell observed for a soil sample exposed to water and a liquid composition as used in the present invention.

FIG. 2 shows a schematic depiction of the injection of the liquid composition in the method of the present invention. FIG. 5 is a top perspective view of an example dispenser insert, according to embodiments of this disclosure.

### DETAILED DESCRIPTION OF THE PREFERRED EMBODIMENTS

The present invention is a method and composition for reducing the swelling capacity of clay-containing soil, the method comprising introducing a liquid composition comprising one or more potassium or ammonium salts and a lignin into the soil.

The method and composition reduce the swelling capacity of soil which contains clay, and also lowers the volume change in such soil by reducing swelling and/or shrinkage of the soil from a first level before injection of the composition into the soil, to a second, lower level, after injection of the composition into the soil, which is a swelling or expansive clay soil.

By an expansive clay soil is meant herein any soil which a content of clay particles (<2 pm) which is greater than about 15%, or a Plastic Limit over 30 as measured using Atterberg Limits, which is a well-known test that is run by any geotechnical engineering laboratory.

According to one embodiment of the invention, any water-soluble salt of potassium and/or ammonium may be used. Typically, one or more food grade, highly water-soluble potassium and/or ammonium salts are employed, as it goes completely into suspension and leaves little residue. By highly water-soluble is meant herein a water solubility of at least 28.1 g/100 g water at 0° C. However, it is also possible to use a lower grade of material which is less water-soluble, though such materials tend to leave a lot of build-up in tanks, which then has to be disposed of. If desired, a mixture of potassium salts may be used. By way of example, one or more salts selected from potassium chloride, potassium sulfate, potassium nitrate, potassium carbonate, potassium chlorate, potassium hydroxide, and potassium permanganate may be used. As a mixture of potassium salts, a material such as potash may be employed.

Alternatively, or in addition, one or more salts selected from ammonium chloride, ammonium sulfate, ammonium nitrate, ammonium carbonate, ammonium chlorate, ammonium hydroxide, and ammonium permanganate may be used.

Lignin materials are cross-linked polymers which are derived as a waste product from extracting cellulose from wood pulp. By the terms ‘lignin’ and ‘lignin material’ herein is meant any lignin polymer or a salt or other derivative thereof.

One exemplary type of lignin salts or derivatives which may be used in the present invention includes lignin sulfonates, or lignosulfonates. Lignosulfonates are water-soluble anionic polyelectrolyte polymers which are by-products from the production of wood pulp using sulphite pulping.

According to one embodiment of the invention, the lignin comprises one or more of ammonium lignosulphonate, calcium lignosulphonate or magnesium lignosulphonate. Typically, the lignin comprises ammonium lignosulphonate.

The liquid composition typically also has a substantially neutral pH, i.e. in the range of about 6.5 to 7.5. Therefore, if necessary, the composition may be neutralized to this pH range with a requisite amount of a suitable neutralizing agent. This neutralizing agent may, for example, comprise an alkali such as sodium hydroxide, but other suitable neutralizing agents may also be used and will be readily apparent to the person skilled in the art.

According to one embodiment of the invention, the liquid composition comprises potash for the provision of the one or more potassium and/or ammonium salts, the lignin comprises ammonium lignosulphonate, and sodium hydroxide is employed as a neutralizing agent. Water constitutes the remainder of the composition.

According to one embodiment of the invention, the liquid composition may comprise, as a weight percentage of the overall liquid composition:
from about 15 wt % to about 50 wt % of the one or more potassium and/or ammonium salts, or from about 20 wt % to about 35 wt %;
from about 2 wt % to about 12 wt % of the lignin, or from about 4 wt % to about 10 wt %;
if present, from about 0.1 wt % to about 0.6 wt % of the neutralizing agent, or from about 0.2 wt % to about 0.5 wt %; and
from about 50 wt % to about 80 wt % of water, or from about 60 wt % to about 70 wt %.

According to one embodiment of the invention, the method employed to introduce the liquid composition into the soil may comprise injection of the composition. According to another embodiment, the liquid composition could be mixed with the soil, which would typically be carried out also using lime or cement in combination with the solution. According to further embodiments, the liquid composition could be introduced into the soil by deep mixing (i.e. mechanical blending of in situ soil with slurry grout using a soil mixing tool), spraying, pouring and jet grouting as alternative techniques.

The radius of impact of the liquid composition extends from about 0.3 to at least about 1.5 m radially from the point of entry of the composition into the soil, and is defined by a field trial. This is in contrast to previous lime slurry pressure injection techniques and materials discussed hereinabove, which have a significantly lower degree of penetration and diffusion into the soil, and hence, provide a significantly lower degree of stabilization to the soil.

According to one exemplary embodiment of the invention involving injection of the composition into the soil, the method employed according to the present invention substantially consists in forming in the soil a plurality of holes with a distance in the order of about 0.5 m to about 4 m apart, or about 0.6 m to about 3 m apart, or about 1.0 m to about 1.5 m apart. According to one aspect of the invention, there may be three or more injections carried out at any given site, of which one injection may be only of water to help disperse the liquid composition.

The holes can have variable diameters according to requirements and can be provided substantially vertically or at any desired angle with respect to the vertical. According to one aspect of the invention, the depths may be typically between about 0.25 to about 0.5 meters in diameter.

The depth of the holes may also vary according to depth of the clay formation and the “active zone” of the formation. According to one aspect of the invention, the depths may be typically between about 1.5 to about 5 meters in depth.

Once the holes have been formed, a tube is then inserted or driven into the holes and the liquid composition is injected therein, and subsequently spreads and diffuses into the soil.

The injection of the liquid composition may be carried out under pressure, such as hydraulic pressure. According to one embodiment, the injection technique employs a pressure of between about 344.7 kPa to about 1.38 MPa (about 50 to about 200 psi).

Once the liquid composition has been injected into the soil, modification of the soil structure begins along the path the injection fluid travels as it enters into the soil mass. Once hydraulic injection pressure is removed from the system, movement of injected fluid into the soil and out of injection seams occurs primarily through a diffusion mechanism. Molecular diffusion occurs in clay soils as a result of chemical gradients.

A principal aim of the present invention is to limit heaves and desiccation under roads, railways, or existing or future buildings.

The liquid composition used in the method of the invention does not require the use of any solids content, such as soil, cement, concrete, sand, earth, resin, latex, or any other form of solid aggregate or waste. It is injected into the soil in a liquid form, with no solid materials therein. The chemical liquid composition diffuses into and reacts with the clay particles, and is able to modify its behavior.

An innovative aspect of the present invention is that the water in the liquid composition does not cause the hydration of the clay that results in further swelling pressure and thus surface heave. This method can be therefore be realized under roads, railways, or existing or future buildings.

The liquid composition employed in the present invention possesses excellent stabilization properties when used as a treatment for reducing swelling or shrinkage in soil.

The lignin is used in the composition to modify the molecular structure of the soil particularly those with a clay content, such as expansive or swelling clays. Lignin is a biomolecule that belongs to the family of polyphenolic polymer macromolecules, the main components of wood. Testing has shown that lignin has the particularity of reducing the swelling of clays during the phase injection, unlike the injection potassium salts alone (see Table 1 below), or other cations. However, the presence of one or more potassium salts has been found to be most beneficial to reducing inundation swell followed by the lignin (see Table 2 below). A potassium salt is therefore mixed with the lignin to constitute the liquid composition.

TABLE 1
Significant variables to injection swell from full factorials tests (N = 47)
(“Lab methodology for optimizing injected chemical modifiers utilized
in swell reduction” Marshall Bruce Addison 1995).

| Chemical Designation | P-level |
|---|---|
| Lignin | <0.000 |
| Potassium Salt | 0.262 |
| Caustic Agent | .809 |

TABLE 2
Significant variables to inundation swell from full factorials tests (N = 47)
(“Lab methodology for optimizing injected chemical modifiers utilized
in swell reduction”, Marshall Bruce Addison 1995).

| Chemical Designation | P-level |
|---|---|
| Lignin | 0.001 |
| Potassium Salt | <0.000 |
| Caustic Agent | 0.671 |

In each of Tables 1 and 2, the values are statistically significant if the P-level is less than 0.05: it can be seen that this is the case in Table 1 for the lignin, and in Table 2 for both the lignin and the potassium salt. The lower the Pi-value, the stronger there is statistical evidence in the testing to support the claim or hypothesis that Inundation Swell or Injection Swell are lowered by that variable.

The method of the present invention is simple and easy to perform, and can be adopted before and after construction of any structures, such as, for example, building foundations, roads and railways.

It has been noted by the inventors that:
in the existing literature, biopolymer injection is not mentioned for the reduction of swelling and/or shrinkage potential of swelling clays;
further, no study addresses the problem of swelling during the injection work phase, which is nevertheless a very sensitive phase in the context of rehabilitation of existing structures;
the injection of such compositions in clay soil of very low permeability brings up the problem of the diffusion of the cations in a sufficiently large radius to make the injection feasible to sufficiently stabilize the soil, this problem is not one which is addressed in the literature;
use of swell testing to simulate chemical pressure injection has not been reported in the literature, testing has usually relied on mixing modifying chemicals with the expansive soils prior to compaction and swell testing; and to test the liquid composition used in the present invention, a new laboratory testing was used (Marshall Bruce Addison Ph.D. 1995). This test was used to simulate the injection under pressure and to verify in the laboratory the swelling of the clay during the injection phase and its diffusion within the sample.

Also provided herein according to the present invention is a composition suitable for reducing the swelling capacity of clay-containing soil, or lowering volume change in soil, the composition comprising one or more potassium and/or ammonium salts and a lignin, wherein the composition is a liquid.

Any water-soluble salts of potassium and/or ammonium may be used.

Typically, a food grade, one or more highly water-soluble potassium and/or ammonium salts are employed, as it goes completely into suspension and leaves little residue. However, it is also possible to use a lower grade of material which is less water-soluble, though such materials tend to leave a lot of build-up in tanks, which then has to be disposed of. If desired, a mixture of potassium and/or ammonium salts may be used. By way of example, one or more salts selected from potassium chloride, potassium sulfate, potassium nitrate, potassium carbonate, potassium chlorate, potassium hydroxide, and potassium permanganate may be used. As a mixture of potassium salts, a material such as potash may be employed. Alternatively, or in addition, one or more salts selected from ammonium chloride, ammonium sulfate, ammonium nitrate, ammonium carbonate, ammonium chlorate, ammonium hydroxide, and ammonium permanganate may be used.

Any lignin materials which are considered to be safe for introduction into a soil environment may be used. One exemplary type of lignin salts or derivatives which may be used in the present invention includes lignin sulfonates, or lignosulfonates.

According to one embodiment of the invention, the lignin comprises one or more of ammonium lignosulphonate, calcium lignosulphonate or magnesium lignosulphonate. Typically, the lignin comprises ammonium lignosulphonate.

The liquid composition must also have a substantially neutral pH, i.e. in the range of about 6.5 to 7.5. Therefore, if necessary, the composition must be neutralized to this pH range with a requisite amount of a suitable neutralizing agent. This neutralizing agent may, for example, comprise an alkali such as sodium hydroxide, but other suitable neutralizing agents may also be used and will be readily apparent to the person skilled in the art.

According to one embodiment of the invention, the liquid composition comprises potash for the provision of the potassium salts, the lignin comprises ammonium lignosulphonate, and sodium hydroxide is employed as a neutralizing agent. Water constitutes the remainder of the composition.

The liquid composition further does not contain any solids content, such as soil, cement, concrete, sand, earth, resin, latex, or any other form of solid aggregate or waste.

According to one embodiment of the invention, the liquid composition may comprise, as a weight percentage of the overall liquid composition:
from about 15 wt % to about 50 wt % of the one or more potassium and/or ammonium salts, or from about 20 wt % to about 35 wt %;
from about 2 wt % to about 12 wt % of the lignin, or from about 4 wt % to about 10 wt %;
if present, from about 0.1 wt % to about 0.5 wt % of the neutralizing agent, or from about 0.2 wt % to about 0.4 wt %; and
from about 50 wt % to about 80 wt % of water, or from about 60 wt % to about 70 wt %.

Compositions comprising one or more potassium and/or an ammonium salts and a lignin material are known; however, they either contain solid matter, or are manifestly unsuitable for reducing the swelling capacity of clay-containing soil, or lowering volume change in clay-containing soil. For example, on the one hand, some compositions contain solids such as soil or latex solids (KR101905754), or at least 100 parts by weight of at least one member selected from sand, earth, industrial waste, marine and desert sand (KR101852957). On the other hand, some fertilizer compositions contain a potassium salt and a lignin material, amongst several other components; however, the introduction of these compositions into soil is not able to reduce the swelling capacity of clay-containing soil, nor have any control over the change in volume of the soil, as they contain far too little potassium and lignin therein compared to the composition of the invention to make any difference.

Also provided herein according to the present invention is a method of manufacturing a composition comprising one or more potassium and/or ammonium salts and a lignin, the method comprising:

i) adding one or more potassium and/or ammonium salts to an amount of water to obtain a solution;

ii) adding the lignin to the solution; and

iii) if necessary, bringing the solution to a pH between about 6.5 and about 7.5.

When manufacturing the liquid composition to be used in the present invention, typically the one or more potassium salts are added to an amount of water, and the mixture is slowly stirred until the one or more potassium salts have substantially completely dissolved. The lignin is then added to the resultant solution, and this mixture is stirred. Finally, if required, the neutralizing agent (such as one containing NaOH) is added to bring the liquid composition to a neutral pH.

Once the liquid composition has been prepared, it should then be diluted as required for the field application. According to embodiments of the invention, the liquid composition may be used with no dilution at all, or with a ⅓ cut or a ½ cut, i.e. wherein a ⅓ cut comprises approximately 33 wt % water, with one part of water and 2 parts of the liquid composition, and a ½ comprises approximately 50 wt % water and 50 wt % of the liquid composition.

### EXAMPLES

Evidence of samples treated with the liquid composition employed in the invention was attained through swell reduction, lowering of final moisture content and X-ray diffraction testing. The liquid composition herein has been named RemediaCLAY.™

X-ray diffraction testing revealed modification of montmorillonite clay in optimally treated samples with RemediaCLAY.™

The level of diffusion is good and was carried out on all the volume of the sample.

Testing has been carried out in relation to soil samples of expansive clay taken from under a building which had suffered apparent foundation distress on the north east side of the building, with cracks in the floor and brickwork that appeared to be the result of foundation settlement.

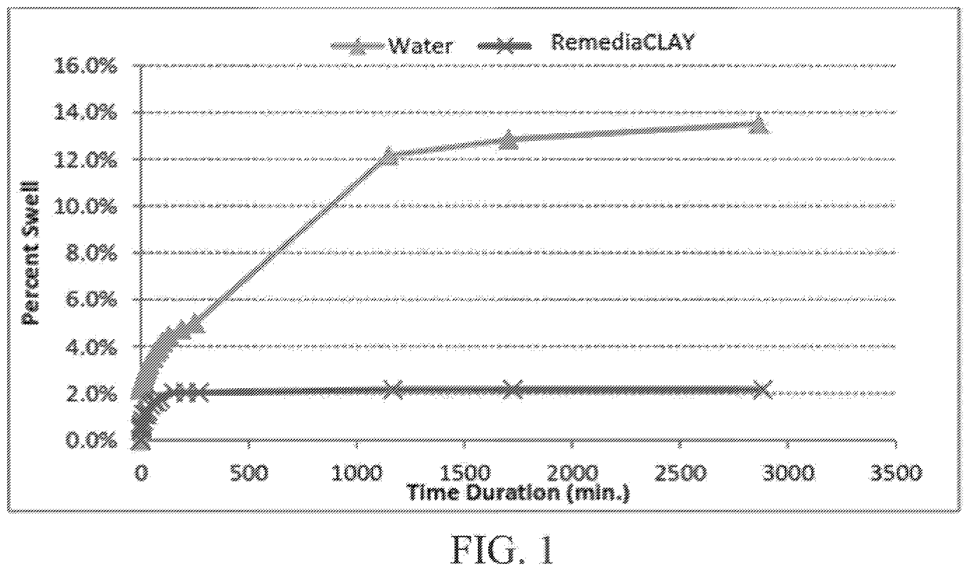

In order to determine how treatment with the composition of the invention would affect the soil to stop further settlement and help repair the foundation, two identical soil samples were taken from the site for a reactivity study. This study was conducted by preparing the two identical soil samples and compacting each sample into a consolidation ring. This ring prevents the samples from any horizontal movement. These samples were then placed into two separate baths, one in water and the other with RemediaCLAY™. A dial gauge was used to measure the swells from each sample. The results of this study are shown in FIG. 1.

The graph in FIG. 1 shows that the degree of swelling experienced by the soil sample submerged in water only was an increase in volume of over 13.5% over a period of almost 3000 minutes (or 50 hours). In contrast, the soil submerged in a RemediaCLAY™ solution experienced only a 2% volume increase over the same period. The disparity of the results of the two treatments further indicated that the treatment of the clay soil with RemediaCLAY™ would have favorable results.

Operating Mode

According to one exemplary embodiment of the invention, the method employed according to the present invention substantially consists in forming in the soil a plurality of holes with a distance in the order of about 0.6 m to about 3 m apart.

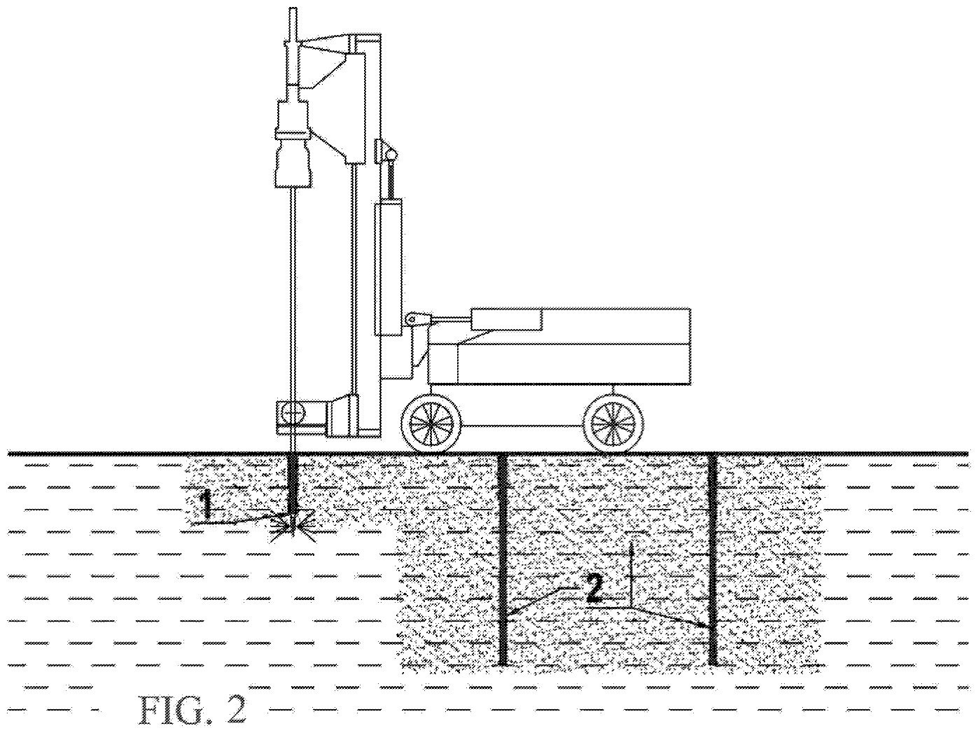

With reference to FIG. 2, a tube 1 is then inserted or driven and the

RemediaCLAY™ liquid composition 2 is injected, using hydraulic injection pressure, into the tube 1 in order that it will diffuse and spread into the soil.

In this exemplary embodiment, the RemediaCLAY™ composition 2 is constituted by a mixture of ammonium lignosulfonate, a mixture of potassium cations (provided by potash), and a neutralizing agent, which is NaOH.

Once the composition 2 has been injected into the soil, modification begins along the path the injection fluid travels as it enters into the soil mass. Once the hydraulic injection pressure is removed from the system, movement of the injected liquid composition into the soil and out of injection seams occurs primarily through a diffusion mechanism. Molecular diffusion occurs in clay soils as a result of chemical gradients.

The range of radius of effect of the liquid composition is from about 0.3 to about 1.5 m from the point of injection.

It can therefore be seen that the method of the present invention and liquid composition used therein is able to provide a greater degree of reduction of the swelling capacity of expansive clay-containing soil, with the composition being able to diffuse and spread much further into the soil than existing formulations used to try and reduce the swelling capacity in expansive clay-containing soils, and also provides significantly reduced levels of swell, thus enabling the safe and sustainable repair of foundations and structures thereon.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

### STATEMENT OF INDUSTRIAL APPLICABILITY

There is a significant commercial need to stabilize soil using a cation-containing composition which is able to reduce swelling and/or shrinkage of swelling clays substantially immediately during injection and in the long term, and which makes the cation-containing solution more effective in a largest possible radius of action. The cation-containing solution should not be harmful to the underground environment.

I claim:

1. A method of reducing the swelling capacity of clay-containing soil, the method comprising introducing a liquid composition comprising one or more potassium and/or ammonium salts and a lignin into the soil.

2. A method according to claim 1, wherein the liquid composition comprises:
a range of between 15 wt % to 50 wt % of the one or more potassium and/or ammonium salts;
a range of between 2 wt % to about 12 wt % of said lignin; and
a range of between 50 wt % to about 80 wt % of water.

3. A method according to claim 1 wherein the potassium and/or ammonium salts comprise one or more selected from potassium chloride, potassium sulfate, potassium nitrate, potassium carbonate, potassium chlorate, potassium hydroxide, and potassium permanganate; and/or ammonium chloride, ammonium sulfate, ammonium nitrate, ammonium carbonate, ammonium chlorate, ammonium hydroxide, and ammonium permanganate.

4. A method according claim 1, wherein the potassium and/or ammonium salts comprise potash.

5. A method according to claim 1, wherein the lignin comprises one or more lignosulfonates.

6. A method according to claim 5, wherein the lignosulfonates comprise one or more selected from ammonium lignosulphonate, calcium lignosulphonate or magnesium lignosulphonate.

7. A method according to claim 6, wherein the lignosulfonate comprises ammonium lignosulphonate.

8. A method according to claim 1, wherein the liquid composition has a pH between about 6.5 and about 7.5.

9. A method according to claim 1, wherein the liquid composition further comprises an amount of a pH neutralizing agent sufficient to provide a pH between about 6.5 and about 7.5.

10. A method according to claim 1, wherein the liquid composition comprises potash, ammonium lignosulphonate, sodium hydroxide and water.

11. A method according to claim 1, wherein the liquid composition does not contain any solid materials.

12. A method according to claim 1, wherein the liquid composition is introduced into the soil by one or more techniques selected from injection, mixing, deep mixing, spraying, pouring or jet grouting.

13. A method according to claim 12, wherein the liquid composition is introduced into the soil by injection.

14. A method according to claim 13, wherein said injection is at a pressure within a range of between 344.7 kPa to 1.38 MPa (about 50 to about 200 psi).

15. A method according to claim 13, wherein the injection comprises forming in the soil a plurality of holes spaced at a distance within a range of from 0.5 m to 4 m apart.

16. A composition suitable for reducing the swelling capacity of clay-containing soil, the composition comprising one or more potassium and/or ammonium salts and a lignin, wherein the composition is a liquid.

17. A composition according to claim 16, wherein the liquid composition comprises:
a range of between 15 wt % to 50 wt % of the one or more potassium and/or ammonium salts;
a range of between 2 wt % to about 12 wt % of said lignin; and
a range of between 50 wt % to about 80 wt % of water.

18. A composition according to claim 16, wherein the potassium and/or ammonium salts comprise one or more selected from potassium chloride, potassium sulfate, potassium nitrate, potassium carbonate, potassium chlorate, potassium hydroxide, and potassium permanganate; and/or ammonium chloride, ammonium sulfate, ammonium nitrate, ammonium carbonate, ammonium chlorate, ammonium hydroxide, and ammonium permanganate.

19. A composition according to claim 16, wherein the potassium and/or ammonium salts comprise potash.

20. A composition according to claim 16, wherein the lignin comprises one or more lignosulfonates.

21. A composition according to claim 20, wherein the lignosulfonates comprise one or more selected from ammonium lignosulphonate, calcium lignosulphonate or magnesium lignosulfonate.

22. A composition according to claim 21, wherein the lignosulfonate comprises ammonium lignosulphonate.

23. A composition according to claim 16, wherein the liquid composition has a pH between about 6.5 and about 7.5.

24. A composition according to claim 16, wherein the liquid composition further comprises an amount of a pH neutralizing agent sufficient to provide a pH between about 6.5 and about 7.5.

25. A composition according to claim 16, wherein the liquid composition comprises potash, ammonium lignosulfonate, sodium hydroxide and water.

26. A composition according to claim 16, wherein the liquid composition does not contain any solid materials.

27. A method of manufacturing the composition according to claim 16, the method comprising:
i) adding one or more and/or ammonium potassium salts to an amount of water to obtain a solution;
ii) adding the lignin to the solution; and
iii) measuring pH of said solution to confirm that said pH is within a range of between 6.5 and 7.5.
